(19) United States
(12) Patent Application Publication
(10) Pub. No.: US 2014/0209375 A1
(43) Pub. Date: Jul. 31, 2014

(54) ELECTRICALLY CONDUCTIVE MATERIAL, EMITTER CONTAINING ELECTRICALLY CONDUCTIVE MATERIAL, AND METHOD FOR ITS MANUFACTURE

(71) Applicants: Sven Linow, Darmstadt (DE); Maike Klumpp, Weiden (DE)

(72) Inventors: Sven Linow, Darmstadt (DE); Maike Klumpp, Weiden (DE)

(73) Assignee: HERAEUS NOBLELIGHT GMBH, Hanau (DE)

(21) Appl. No.: 14/236,954

(22) PCT Filed: Jul. 4, 2012
(86) PCT No.: PCT/EP2012/002802

§ 371 Date: Feb. 4, 2014

(30) Foreign Application Priority Data
Aug. 5, 2011 (DE) 10 2011 109 577.6

(51) Int. Cl. H01B 5/12; H01B 13/00

(52) U.S. Cl. CPC H01B 5/12; H01B 13/0036
USPC 174/520; 174/128.1; 29/825

(57) ABSTRACT

A method is provided for manufacture of an electrically conductive material, including the steps of: (a) providing a structure made of electrically conductive fibers, and (b) producing a carbon-based, electrically conductive matrix at least partially enveloping the electrically conductive fibers. Before or after producing the matrix, at least part of the electrically conductive fibers are interrupted in the direction of possible current flow. Electrically conductive materials obtained in corresponding manner are also provided. An emitter is specified that contains a transparent or translucent housing and an electrically conductive material according to the above. The electrically conductive materials have an increased electrical resistance. These allow emitters of virtually any length to be operated at customary line voltages.

### CROSS-REFERENCE TO RELATED APPLICATIONS

This application is a Section 371 of International Application No. PCT/EP2012/002802, filed Jul. 4, 2012, which was published in the German language on Feb. 14, 2013, under International Publication No. WO 2013/020621 A3 and the disclosure of which is incorporated herein by reference.

### BACKGROUND OF THE INVENTION

The invention relates to a method for manufacturing an electrically conductive material, an electrically conductive material per se, and an emitter containing an electrically conductive material.

The electrically conductive materials at issue are conceivable for use as electrically heatable elements for use in incandescent lamps or infrared emitters. Accordingly, the electrically conductive materials are suitable, in particular, for the targeted emission of beams in the visible, and in particular in the non-visible, range of wavelengths.

Electrically conductive materials of this type are often based on carbon or consist mainly of carbon. However, electrically conductive materials of the type at issue, used as a starting material, can comprise various materials alternative to or in addition to carbon that provide an electrical conductivity.

In ready-to-use, pre-assembled form, the electrically conductive materials at issue can also be referred to as an incandescent filament, glow wire, glow coil, heating rod, and, in particular, as a filament. Insofar as reference is made to filaments hereinafter, this shall always also comprise the electrically conductive material from which the filament is made.

The manufacture of electrically conductive materials, in particular of carbon-based materials, for use as an electrically heated element in incandescent lamps or infrared emitters has been known for a long time. The electrically conductive materials undergo a large number of manufacturing steps aimed at preparing the materials for long-lasting use at temperatures above 800° C.

In this context, it is generally difficult to manufacture all materials and/or filaments of a production lot to be within a defined tolerance range in terms of the electrical and mechanical properties on account of variations in the properties of the starting material, and to thus ensure that the radiation source has constant, consistent properties. In this context, the electrical properties are generally to be adjusted appropriately, such that the desired power (in the case of infrared radiation) or color temperature (in the case of incandescent lamps) at a given nominal voltage and given radiation source dimensions is attained. Moreover, the electrically conductive material should comprise sufficient mechanical strength and dimensional stability. Lastly, the effort and costs involved in the manufacture of the electrically conductive material should be at a reasonable level.

Depending on the desired purpose of application of the electrically conductive materials at issue herein, the requirements mentioned above generally will vary and various technical solutions will be selected by a person skilled in the art in order to meet the requirements. An overview of the manufacture of electrically conductive materials is provided in John W. Howell, Henry Schroeder: History of the Incandescent Lamp, The Maqua Company, Schenectady, N.Y. (1927).

The electrically conductive materials can be manufactured, for example, by enveloping fibers, which are electrically conductive, having an appropriate enveloping material. The enveloping material can then provide a suitable matrix for the electrically conductive fibers, in particular after a heat treatment is carried out.

It is obvious then that a person skilled in the art aiming to attain certain properties in accordance with the profile of requirements mentioned above aims to vary the electrical properties of the electrically conductive material in a targeted manner. A number of pertinent approaches are known from the prior art.

First, it is conceivable to vary the cross-sectional area of the electrically conductive material, in particular in pre-assembled form as a filament, at constant surface. In the case of electrically conductive materials designed in the shape of stretched tapes, this allows the electrical parameters to be adjusted over a wide range at approximately constant circumference and decreasing thickness. However, if extended emitters are to be operated at common voltages, the stretched tapes used as electrically conductive material prove to be too thin, too brittle and too fissure-prone.

From European Patent EP 0 700 629 B1 are known electrically conductive materials, in particular pre-assembled as filaments, which provide high power values at large emitter length combined with reasonable stability of the electrically conductive material, namely the filament. However, the electrical resistance of the filaments proposed therein is insufficient for operation of very long emitters at common electrical voltages in industrial applications. Moreover, it has been evident that varying the type of electrically conductive fiber within the electrically conductive material or of the type of resin used as a matrix forming agent provides no decisive change of the property, if the filament made of electrically conductive material is to also be safe during processing.

Alternatively or in addition, it is known to dope starting materials of the electrically conductive material in order to attain certain electrical properties. Accordingly, an electrically conductive material can be manufactured, for example, from crystalline carbon, amorphous carbon, and further substances for adjusting the conductivity, for example nitrogen and/or boron. Materials of this type are described in U.S. Pat. No. 6,845,217. U.S. Pat. No. 6,627,144 proposes the use of organic resins, carbon powder, silicon carbide, and boron nitride.

However, electrically conductive material manufactured by these means is characterized in that filaments and/or heating rods obtained from them must not have less than a certain, considerable thickness. Moreover, the length of the filaments and/or heating rods is strongly limited. The cross-sectional area of the filaments resulting from these mechanical requirements leads to high conductivity at small surface area. Moreover, the low mechanical stability of the filaments renders industrial processing difficult, if not impossible.

In order to obtain good mechanical stability at lower conductivity, it is known to use electrically conductive materials that are based on fibers or fiber-containing material for lamps or emitters. In this context, low thickness values of the pre-assembled electrically conductive material (for example in the form of a filament or heating rod) at large surface area values can be attained, such that the higher conductivity as compared to amorphous graphite can be compensated in the fibers. The filaments are usually manufactured by a carbonization and, if applicable, a graphitization.

The carbonization usually proceeds at temperatures between 400° C. and 1,500° C. in an inert atmosphere, wherein hydrogen, oxygen, nitrogen, and, if applicable, further elements being present are eliminated from the material enveloping the electrically conductive fibers (enveloping material) resulting in an electrically conductive material having a high carbon content being produced. In the process, the enveloping material turns into a matrix that envelopes the electrically conductive fibers.

A graphitization proceeds at temperatures between 1,500° C. and 3,000° C. in an inert atmosphere at atmospheric pressure or in a vacuum, wherein any non-carbon components still present after carbonization evaporate from the electrically conductive fibers and matrix enveloping them, and wherein the micro-structure of the electrically conductive material is influenced by this. The matrix in this context shall be understood to be the carbonized material enveloping the electrically conductive fibers (i.e., the carbonized enveloping material).

For adjusting the electrical properties as desired, it is known in the context of the electrically conductive materials to dope the electrically conductive material. U.S. Pat. No. 487,046 describes the addition of substances from the gas phase, namely, in particular, of carbides, for incorporation into the electrically conductive material. This changes the electrical properties of the electrically conductive material. However, this method necessitates a laborious third heat treatment, in which each filament needs to be treated separately. Moreover, doping with carbides produces a very brittle, electrically conductive material, which is not suitable for use in large emitters.

The electrical properties of the electrically conductive material can also be influenced as early as during a step of graphitization. The maximal temperature of graphitization and its duration influence to a certain degree the conductivity of the electrically conductive material thus generated. This effect is described in H. O. Pierson: Handbook of Carbon, Graphite, Diamond and Fullerenes, Noyes Publications, Park Ridge, N.J. (1993). However, since the high temperatures used for graphitization lower the resistance of the electrically conductive material, the effect is counter-productive in the manufacture of electrically conductive material for long emitters, since electrically conductive materials having high resistance at high filament temperatures are needed for long emitters.

The same applies to a deposition of additional carbon onto the surface of the electrically conductive material by pyrolysis, such as has been proposed in U.S. Pat. No. 248,437, for example. A method of this type can result in voids in the electrically conductive material and/or filament being filled, but always leads to a reduction of the resistance, such that this also fails to achieve suitability of the electrically conductive material for use in long emitters.

British patent specification GB 659,992 proposes a method for reducing the cross-section of filaments made of a carbon-based electrically conductive material. An etching process in the gas phase is used in this context. The etching treatment is very laborious though and comprises not only the steps of carbonization and graphitization, but also multiple additional steps. Moreover, only electrically conductive materials and/or filaments which have not yet been provided with electrical contacts can be treated with the etching process. Filaments designed to take up strong electrical currents though are provided with electrical contacts as early as before the first heat process. Therefore, this method also cannot be used for manufacturing electrically conductive materials for very long emitters.

In summary, it can be stated that previously known electrically conductive materials and/or methods for manufacturing them basically do not allow the electrical properties of the material, in particular in the form of a filament, to be influenced by selecting electrically conductive components of the material, in particular of electrically conductive fibers. For adjusting certain electrical properties, it has therefore been customary thus far to vary the length and/or cross-sectional area of the electrically conductive material and/or to change the electrically conductive material in one of the ways described above and/or after manufacture in terms of the composition and/or structure thereof.

The availability of electrically conductive materials and/or methods for the manufacture thereof is unsatisfactory, however, with regard to the use of electrically conductive materials in very long emitters at customary electrical voltages.

### BRIEF SUMMARY OF THE INVENTION

The invention is based on the object of making a contribution to overcoming at least one of the disadvantages resulting from the prior art, as described above, that relate to the availability of electrically conductive materials.

Specifically, the invention is based on the object of providing an electrically conductive material and a method for the manufacture thereof, which allows for the operation of emitters, in particular of infrared emitters, of any length at customary line voltages.

The invention is also based on the object of providing an electrically conductive material and/or method for the manufacture thereof that is suitable for use in emitters, in particular in infrared emitters, and in particular in carbon infrared emitters, and which can be manufactured in great lengths, i.e. of more than 0.25 m, preferably of more than 0.5 m, more preferably of more than 1.0 m, and particularly preferably of more than 2.0 m.

Moreover, the invention is also based on the object of providing an electrically conductive material and/or method for the manufacture thereof, which comprises higher electrical resistance at otherwise identical design (length, diameter) than electrically conductive materials known thus far.

A contribution to meeting at least one of the objects specified above is made by a method for the manufacture of an electrically conductive material, wherein the method comprises the steps of:
a) providing a structure made of electrically conductive fibers; and
b) producing a carbon-based, electrically conductive matrix that envelopes the electrically conductive fibers at least in part;
   wherein, before or after producing the matrix, at least part of the electrically conductive fibers are interrupted in the direction of a possible current flow.

What the invention attains in a particularly artful way is that a current flow oriented in a possible direction of current flow through the electrically conductive material is forced, at least over regions thereof, to proceed through the matrix that envelopes the electrically conductive fibers at least in part. Thus, the electrical properties of the electrically conductive material can be varied not only in a very targeted and accurate manner, but also across a surprisingly broad range in thus far unsurpassed manner.

Initially, the fraction of fibers, which are being interrupted, can be used to determine which fraction of the current flow is forced to proceed through the matrix material. For this purpose, a part of the electrically conductive fibers or all fibers can be interrupted once or multiple times along their length.

On the other hand, the electrically conductive matrix material can be selected appropriately overall to design the electrical properties of the electrically conductive material very accurately and reproducibly. For this purpose, a matrix material having a rather low or a high electrical conductivity can be selected.

Forcing the matrix material to be included in the flow of electrical current, as provided by the invention, is an effective way of overcoming a problem that is a well-known problem from the prior art, namely that the electrical properties of the electrically conductive material are determined largely by the electrically conductive fibers.

In this context, an electrically conductive material in the scope of the invention comprises, on the one hand, a base material that is suitable for further processing and/or shaping. However, the term, electrically conductive material, in the scope of the invention also comprises materials which already experienced some level of pre-assembly, and specifically comprises a filament, an incandescent filament, a glow wire, a glow coil, a heating rod, or the like. Moreover, the electrically conductive material can already comprise electrical contacts.

In particular, though without being limiting, the electrically conductive material according to the invention relates to materials or filaments for high intensity emitters, in particular lamps or infrared emitters, whose filament temperature clearly exceeds the oxidation limit of carbon on air, and which therefore are operated in a vacuum or in a protective atmosphere.

The term, possible direction of current flow through the electrically conductive material, basically describes any direction in which current can be conducted through the electrically conductive material according to the invention. However, a preferred direction of current flow is along a direction of longitudinal extension of the electrically conductive material. The direction of longitudinal extension can coincide, in particular, with the longitudinal axis of an emitter housing, in which the electrically conductive material can be introduced, in particular as a filament. However, it is always possible in this context that the electrically conductive material be designed to be coil-shaped or meandering, such that a direction of longitudinal extension of the electrically conductive material in this respect may deviate from a longitudinal axis of an enveloping housing.

According to a first preferred embodiment of the method according to the invention, the electrically conductive material is manufactured to have a carbon content of at least 95% by mass (mass %). A preferred carbon content is, in particular, more than 96 mass %, particularly preferably more than 97 mass %. However, a preferred upper limit of the carbon content is 99.6 mass %.

The electrically conductive fibers within the electrically conductive material can include carbon fibers, silicon carbide fibers, fibers having ceramic components, or a mixture of at least two of these. Provided carbon fibers are used, these are preferably obtained from poylacrylonitrile (PAN), tar, viscose, or a mixture of at least two these.

According to another advantageous embodiment, carbon fibers based on polyacrylonitrile (PAN) having carbon nano tubes aligned with the fiber axis are used. This allows the conductivity of the carbon fibers in the fiber direction to be increased. This most often results in lower conductivity transverse to the fiber direction, which can result in higher resistance.

According to a particularly preferred embodiment of the method according to the invention, the specific electrical conductivity of the matrix is lower than that of the electrically conductive fibers. A current flow that is forced through at least a partial region of the matrix, as provided by the invention, can thus lead to an overall increase in the electrical resistance of the electrically conductive material altogether.

Preferably, the specific electrical conductivity of the matrix is lower by a factor of at least 5, preferably at least 10, as compared to the electrically conductive fibers.

A preferred refinement of the method provides for the use of electrically conductive fibers, in particular of carbon fibers, and in particular of PAN-based carbon fibers, which have a resistivity at room temperature of 1.0×10⁻³ to 1.7×10⁻³ Ωcm, particularly preferably of 1.6×10⁻³ Ωcm. In addition or separately, the use of an enveloping material that has a resistivity at room temperature of more than 10⁷ Ωcm, particularly preferably of more than 10¹⁶ Ωcm, is preferred. In this context, the enveloping material shall be understood to be the material that envelopes, at least in part, the electrically conductive fibers, from which the electrically conductive matrix is manufactured—in particular through carbonization. The stated values of the resistivity refer to the determination by a measuring method in accordance with DIN IEC 60093:1983; Test Methods for ElectroInsulating Materials; Specific Through Resistance and Specific Surface Resistance of Solid, Electrically-Insulating Materials.

The matrix can preferably be produced through a high temperature treatment of a thermoplastic or duroplastic material or a mixture thereof that envelopes the structure made up of electrically conductive fibers in a temperature range of 600° C. to 1,500° C. A temperature range of 800° C. to 1,200° C. is particularly preferred in this context. In this context, the above-mentioned material that envelopes the electrically conductive fibers corresponds to the earlier-mentioned enveloping material from which the electrically conductive matrix is produced. The high temperature treatment in this context can, in particular, comprise a carbonization. If applicable, a graphitization may follow after a carbonization. Both process steps have already been illustrated above. The material that envelopes the electrically conductive fibers and is to be treated with high temperatures (enveloping material) can preferably coat, bind, hold or impregnate the structure made up of electrically conductive fibers.

It is preferred to produce a matrix from thermoplastic and/or duroplastic material. Further filling agents, such as inorganic particles, preferably oxides, sulfates, aluminates, or mixtures thereof, can be added to the thermoplastic and/or duroplastic material within the enveloping material.

Provided the method for manufacturing an electrically conductive material comprises the use of thermoplastic material as the enveloping material and for conversion into the matrix, a preferred embodiment of the thermoplastic material includes polypropylene, polyamide, polybutyleneterephthalate, polyethyleneterephthalate, polycarbonate, polysulfone, polyphenylether, polyphenylenesulfide, polyetheretherketone, polyphthalamide, polyetherimide, polyethersulfone, or a mixture of at least two of these.

In refinements comprising the use of duroplastic material as the enveloping material, the use of a duroplastic material that includes a vinylester resin, a phenol resin, an epoxide resin, or a mixture of at least two of these is preferred.

Generally, a refinement of the method according to the invention is preferred in which the enveloping material that is used comprises a thermoplastic material as the basis of the matrix. However, alternatively or in addition, the enveloping material can just as well comprise a duroplastic material.

Another preferred embodiment of the method according to the invention comprises the following steps:
a) providing the structure made up of electrically conductive fibers by a two-dimensional precursor structure containing electrically conductive fibers;
b) carbonizing the fractions of the two-dimensional precursor structure that are not the electrically conductive fibers; and
c) interrupting at least a part of the electrically conductive fibers by introducing voids, in particular bore holes.

In this context, the two-dimensional precursor structure according to step (a) can, in particular, comprise a so-called carbon fiber tape, preferably a unidirectional and/or thermoplastic carbon fiber tape. In a two-dimensional precursor structure and/or carbon fiber tape, electrically conductive fibers can be attached to or embedded in an enveloping material, in particular a thermoplastic enveloping material. The two-dimensional precursor structure, in particular a carbon fiber tape, can have a tape-like appearance in this context. A unidirectional two-dimensional precursor structure, in particular a carbon fiber tape, is characterized in this context by having a parallel attachment of electrically conductive fibers, in particular in the direction of the longitudinal extension of the two-dimensional precursor structure, in particular of the carbon fiber tape.

The procedural step according to (b) shall in this context be understood to be a procedural step, in which the entire two-dimensional precursor structure, in particular the carbon fiber tape, is exposed to the heat treatment according to the carbonization method described above. However, only the fractions that are not the electrically conductive fibers according to the invention, in particular made of thermoplastic and/or duroplastic polymers, form the matrix, which envelopes the electrically conductive fibers within the electrically conductive material. Accordingly, in a preferred refinement, the two-dimensional precursor structure comprises carbon fibers as electrically conductive fibers and/or the fractions of the two-dimensional precursor structure that are not the electrically conductive fibers, in particular an enveloping material, comprise thermoplastic and/or duroplastic material.

The introduction of voids according to step (c) can be effected, in particular, by placing bore holes. A laser, in particular of a wavelength of 10.2 μm or a wavelength of 1,064 nm, can be used in this context. If a laser is used to place bore holes, the use of a CO₂ laser is preferred. For introducing bore holes into a two-dimensional precursor structure for targeted interruption of the electrically conductive fibers, a preferred bore hole pattern has bore hole diameters of 0.2 mm each and/or has the spacing of the bore holes with respect to the width of the two-dimensional precursor structure be 1 mm, and/or the spacing of the bore holes with respect to the length of the two-dimensional precursor structure (i.e., the distance of rows of bore holes among each other) be 1 mm. A two-dimensional precursor structure as specified above, in particular a carbon fiber tape, can also be referred to as a filament, if applicable, in particular wherein the same extends in a direction of longitudinal extension.

A preferred development of the latter embodiment of the method according to the invention provides the two-dimensional precursor structure to be cut-to-size prior to the carbonization. In this context, the two-dimensional precursor structure, in particular the carbon fiber tape, is preferably cut-to-size appropriately such that the electrically conductive fibers extend parallel to the cutting edge. This allows for accurate and reproducible adjustment of the electrical properties by the subsequent introduction of bore holes. The electrical resistance of the electrically conductive material can be adjusted reproducibly and accurately by a further refinement of the method, according to which at least two two-dimensional precursor structures, in particular carbon fiber tapes, are laminated onto each other such that they are aligned at an angle different from 0°. Accordingly, selecting the angle between the at least two two-dimensional precursor structures allows for adjustment of the electrical properties over a very wide range.

According to another preferred embodiment of the method according to the invention, the structure made up of electrically conductive fibers is selected from the group consisting of:
a plurality of fiber bundles;
a woven material made of fibers or a plurality of fiber bundles or at least two of these;
a braided material made of fibers or a plurality of fiber bundles or at least two of these;
a knitted material made of fibers or a plurality of fiber bundles or at least two of these;
a knitted fabric made of fibers or a plurality of fiber bundles or at least two of these; or a combination of at least two of these.

Fiber bundles of the type mentioned above can also be referred to as rovings. These terms are used synonymously herein. Rovings are bundles of fibers, in particular of carbon fibers, which preferably have great length. Moreover, rovings preferably are non-twisted fiber bundles. Commercial rovings are commercially available containing 12,000; 3,000; and, more rarely, 1,000 fibers per roving. The diameter of a single carbon fiber in this context generally is approx. 5 μm to approx. 8 μm.

That there exists only a very limited number of rovings containing any other number of fibers illustrates again the limitation of the technically feasible variations of different electrically conductive materials and/or filaments according to the prior art, since broadly varying resistance values cannot be covered by the few commercially available rovings at this time.

Another preferred refinement of the latter embodiment of the method relates to a method, in which, for production of the matrix, the structure made up of electrically conductive fibers is enveloped with an enveloping material, wherein the composite thus generated is cut-to-size appropriately before a subsequent step of graphitization such that at least part of the electrically conductive fibers are interrupted in the direction of a current flow through the electrically conductive material. According to another refinement of the invention, it can just as well be preferred to have the cutting-to-size proceed before a step of carbonization.

The term, enveloping material, has been illustrated above and preferably refers to a thermoplastic and/or duroplastic material, particularly preferably just a thermoplastic material. For definition of the direction of current flow, reference is made to the explanations provided above. Accordingly, a direction of current flow, in particular a direction of longitudinal extension of the electrically conductive material, can generally be any possible direction, in which current can be conducted through the electrically conductive material.

Preferably, the composite comprising the structure made up of the electrically conductive fibers and the enveloping material is consolidated before further processing, which means that it is solidified mechanically and/or compacted. The consolidation can be associated with exposure to heat, in which case this would be a thermal consolidation. A consolidation can be implemented, for example, by rolling or heating the composite or by both. Moreover, the structure made up of the electrically conductive fibers can be subjected to a heat treatment, even before forming the composite, namely before enveloping the structure with the enveloping material. Preferably, the enveloping material can coat, bind, hold, or impregnate the structure made up of electrically conductive fibers.

Moreover, it is preferred that all fibers of the structure made up of electrically conductive fibers are interrupted at least once with respect to two opposite ends of the electrically conductive material, in particular as seen in the longitudinal direction, and in particular with respect to two opposite ends of a filament extending in a direction of longitudinal extension. What is attained according to this development is that not a single fiber within the electrically conductive material, in particular within a filament pre-assembled therefrom, extends from one electrical contact to the opposite electrical contact. Accordingly, the entire electrical current flow is forced to proceed, at least in part, through the matrix. Preferably, the interruption of the electrically conductive fibers is attained by cutting-to-size the composite of electrically conductive fibers and enveloping material.

In this context, a cutting edge defining a direction of longitudinal extension of the electrically conductive material still to be formed from the composite, in the case of a woven material can be inclined at an angle of 20° to 70°, particularly preferably of 40° to 50°, with respect to the weft or, in the case of a braided material, in particular a flat knitted material, can extend parallel to the edge of the braided material.

In other words, what this refinement attains is that the electrically conductive fibers are situated at a certain inclination with respect to the direction of longitudinal extension of the electrically conductive material formed later on. Accordingly, at least part of the fibers, but preferably all fibers, are interrupted at least once in their extension from one end to the opposite end of the electrically conductive material. Rather, the electrically conductive fibers terminate at the upper or lower edge of the electrically conductive material, in particular of a filament, that is pre-determined by the cutting edge before they reach the opposite end. This forces the current flow to proceed through the matrix.

Woven materials are usually produced by guiding one or more wefts through a number of warp threads. Usually, warp threads and wefts are situated at an angle of approximately 90° with respect to each other. In the case of a braided material, at least three threads are placed around each other. Usually, these at least three threads are situated with respect to each other at an angle different from approx. 90°. Unlike in weaving and braiding, non-wovens do not involve the single thread being guided. Instead, the threads, which are often shorter than in braiding and weaving, are placed rather randomly.

According to a further embodiment of the method according to the invention, the structure made of electrically conductive fibers and enveloping material is obtained by mixing the electrically conductive fibers and the enveloping material as a two-dimensional precursor structure in the form of a prepreg or by vapor deposition of the enveloping material onto the electrically conductive fibers as a two-dimensional precursor structure in the form of a deposition structure before being cut-to-size. In this context, a prepreg can, in particular, comprise a woven material, braided material, knitted material, or knitted fabric made of electrically conductive fibers, in particular of carbon fibers, which is being mixed with enveloping material, in particular thermoplastic and/or duroplastic material, and consolidated, if applicable. Preferably, the volume fraction of fibers in the prepreg is 40% to 80%. Varying this ratio allows the electrical resistance of the electrically conductive material thus produced to be additionally influenced in an effective manner. The mixing can comprise a mixing process of solids or a coating and/or soaking with a liquid in this context. The mixing can generally be implemented through a stirring process. A soaking process can be implemented, for example, by a soaking batch or a brush.

Vapor deposition of the enveloping material can proceed, in particular, on a woven material, braided material, knitted material, or knitted fabric made of electrically conductive fibers, in particular carbon fibers. A CVD process (chemical vapor deposition) or a CVI process (chemical vapor infiltration) is preferred for vapor deposition. Accordingly, the vapor deposition process is not limited to coating the structure made up of electrically conductive fibers, but rather can proceed by soaking the electrically conductive structure with the enveloping material.

Another advantageous embodiment of the method provides that the structure made up of electrically conductive fibers includes fiber bundles that are reduced in thickness before they are introduced into the structure or that the thickness of the fiber bundles in the structure is reduced after production of the structure, or both. Reducing the thickness of the fibers before introducing them into the structure and/or of the structure altogether allows the electrical properties of the electrically conductive material to be varied additionally and particularly effectively. Preferably, the fibers are present in the form of fiber bundles or rovings whose thickness is reduced as specified above. Rovings of reduced thickness have, in particular, an elliptical or rectangular cross-section; they preferable are crushed rovings. Alternatively or in addition, the entire structure can be crushed from electrically conductive fibers, in particular by rolling. The thickness of the fiber bundles of reduced thickness preferably is less than 80%, more preferably less than 50%, and particularly preferably less than 25%, of the fiber bundles which have not been reduced in thickness.

In addition or alternatively, the electrical properties can be influenced if an angle of twist between mutually crossing fibers or fiber bundles or both within the structure made up of electrically conductive fibers deviates from 90° in either case. The angle of twist preferably is between 45° and 160°. Preferably, the angle of twist is varied subsequently, after producing the structure made up of electrically conductive fibers by compressing the structure. A targeted change of the angle of twist is an effective means of influencing the path of current flow through the electrically conductive material, namely, in particular, lengthens or shortens it. Alternatively or in addition, the fraction of the total path of current flow accounted for by the matrix material can be influenced as well by this means.

Referring to a further desirable increase of the resistance of the electrically conductive material, an embodiment of the method is proposed, in which the carbon is removed from the electrically conductive material. The removal process preferably proceeds after the manufacture of the electrically conductive material is completed. It is particularly preferable in this context to treat the electrically conductive material with a reactive fluid, in particular hydrogen and/or water vapor. In addition, a protective gas, preferably argon, can be used during the treatment.

A contribution to meeting the objects specified above is also made by an electrically conductive material that can be obtained according to a method of the invention. The electrically conductive material can, in particular, serve for generating infrared radiation and is suitable, in particular, for providing filaments, glow filaments, glow wires, glow coils, or heating rods as radiation sources, in particular for infrared emitters. In this context, reference is made to the information provided with respect to the method according to the invention.

A contribution to meeting the objects specified above is also made by an electrically conductive material that includes:
a) a structure made up of electrically conductive fibers; and
b) an electrically conductive matrix, which envelopes the electrically conductive fibers at least in part;
wherein the electrically conductive fibers show higher specific conductivity than the electrically conductive matrix;
wherein the electrically conductive material extends in a direction of longitudinal extension; and
wherein, viewed along the direction of longitudinal extension, at least part of the electrically conductive fibers within the material are interrupted at least once.

Preferably, the electrically conductive material comprises electrically conductive fibers whose fiber length is subject to a bimodal distribution.

In this context, the material extending in a direction of longitudinal extension is equivalent to stating that the material is designed to be elongated. A particularly preferred electrically conductive material has all electrically conductive fibers being interrupted at least once—with respect to an expedient or commercially common length, in particular as a filament. This means that not a single electrically conductive fiber within a preferred electrically conductive material extends from one end of the electrically conductive material to the opposite end without being interrupted at least once. Reference is made to the respective explanations provided with respect to the method according to the invention.

Electrically conductive fibers can be interrupted in the electrically conductive material in the direction of longitudinal extension, in that electrically conductive fibers extend in a direction (fiber direction) that is inclined with respect to the direction of longitudinal extension or in that electrically conductive fibers have one or more voids introduced in them, or both.

The voids can be introduced by mechanical means, in particular by placing bore holes. Preferably, the voids are introduced into the material by a laser. Reference is made to the pertinent explanations provided above.

In case the fiber direction deviates from the direction of longitudinal extension of the electrically conductive material, the fibers do not extend from one end of the electrically conductive material to the other end, since they would first reach the upper or lower edge of the electrically conductive material, where they are forced to end. This forces the current flow to proceed through the matrix. Additionally or alternatively, the fibers can be interrupted once or more times by voids, in particular bore holes, that are introduced by mechanical means. In other respects, reference is made to the corresponding information provided with respect to the method according to the invention.

Within the electrically conductive material, at least 50% by mass (mass %), relative to the electrically conductive material, of the fibers can have a fiber length of no more than 0.5 m, preferably no more than 0.1 m, and particularly preferably no more than 0.05 m. What this design attains is that even with long emitters, at least an essential part of the electrically conductive fibers comprises at least one interruption as seen over the respective length, such that the matrix is always involved in the current flow.

To be concise, although in exemplary manner and without limiting the scope of the invention, for an electrically conductive material (end-product) consisting of a braided material provided with enveloping material and cut-to-size and carbonized, the fiber length preferably is between 5.4 mm (at a width of 5 mm) and 52.3 mm (at a width of 20 mm). In case the thickness is constant, a correlation can be established between the average fiber length and the length of the electrically conductive material (filament length). The shorter the average length of the electrically conductive fibers, the shorter is the emitter, which, operated at 230 V, has a color temperature of 1,250° C. or a wavelength maximum at 1,900 nm. Preferably, the length of the fibers can be between 13 mm (at a width of 5 mm) and 53 mm (at a width of 20 mm), such that an emitter having an emitting filament of 1,200 mm in length operated at 230 V can attain a wavelength maximum at 1,900 nm. Alternatively, the length of the electrically conductive fibers can be between 5.4 mm and 22 mm, in which case an emitter having a filament of 600 mm in length operated at 230 V can attain a wavelength maximum at 1,900 nm. The thickness of the electrically conductive material (filament) can be 0.35 mm in this context.

In an electrically conductive material, which originated from a woven material of electrically conductive fibers and has been cut and carbonized, an equal number of fibers in warp threads and wefts and/or an even distribution of the fibers on the surface in both directions can be attained. In a preferred embodiment that has a cutting edge oriented parallel to the warp threads, the average fiber length can be between 11 mm and 44 mm. In an alternative embodiment that has a cutting edge oriented at an angle of 45° with respect to the warp threads, the average fiber length can be adjusted to be between 7 mm and 28 mm.

A contribution to meeting the objects specified above is also made by an emitter which includes:
a) a transparent or translucent housing; and
b) an electrically conductive material according to the invention that is arranged in the housing.

The electrically conductive material arranged in the emitter can, in particular, be pre-assembled as a filament and/or take the shape of a glow wire, a filament, a glow coil, a heating rod, or a heating plate.

An emitter is preferred in which the electrically conductive material has appropriate flexibility, such that it can be bent into a circle and over its entire length about a radius of 1.0 m, preferably less than 1.0 m, particularly preferably 0.25 m, without fracturing the electrically conductive fibers and/or the matrix and/or without separating the electrically conductive fibers and the matrix. In any case, the electrically conductive material should have a tendency to return to the extended shape imparted on it after being bent.

The emitter can comprise an electrically conductive material having an electrical conductivity, measured as electrical operating voltage per length of the electrically conductive material, in particular of the filament, in a range of more than 1.5, preferably more than 3.0.

The emitter can comprise an electrically conductive material having an electrical conductivity, measured as electrical operating voltage per length of the electrically conductive material, in particular of the filament, in a range of more than 150 V/m, preferably more than 300 V/m.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a schematic plan view of an exemplary embodiment of an electrically conductive material according to the invention;

FIG. 2 is a schematic plan view of a filament comprising a woven material as a starting material;

FIG. 3 is a schematic plan view of a modification of the woven material according to FIG. 2;

FIG. 4 is a series of schematic perspective views illustrating cross-sections of electrically conductive fibers according to another advantageous refinement of the material according to the invention;

FIG. 5 is a schematic depiction of a structure made up of electrically conductive fibers provided in the form of a braided material according to an embodiment of the invention; and

FIG. 6 is a side view of a preferred exemplary embodiment of an emitter according to the invention.

### DETAILED DESCRIPTION OF THE INVENTION

In the following, a number of exemplary embodiments, some of which are additional exemplary embodiments, are presented in a concise manner, wherein, in some cases, reference to the figures is made again.

FIG. 1 shows a schematic view of an exemplary embodiment of an electrically conductive material 1 according to the invention that can be obtained according to a preferred embodiment of the method according to the invention. The electrically conductive material 1 comprises a structure 2 made up of electrically conductive fibers 3. According to the present example, the fibers 3 comprise carbon fibers 4. Moreover, the electrically conductive fibers 3 are surrounded by a carbon-based matrix 5 that is electrically conductive.

The electrically conductive material 1 shown in FIG. 1 is a detail of a filament 6 that can be used as a radiation source in an emitter. The electrically conductive material 1, namely the filament 6, is obtained from a two-dimensional precursor structure 7, which comprises a unidirectional carbon fiber tape 8 in the present case. The electrically conductive fibers 3 are arranged in the direction of longitudinal extension and parallel to each other within the carbon fiber tape 8. The matrix 5 was formed by carbonization of the enveloping material of the electrically conductive fibers 3. The enveloping material is a thermoplastic material in the present carbon fiber tape 8. A possible direction of current flow 9 in the present filament 6 is predetermined by the direction of longitudinal extension 10 of the filament. Moreover, the filament 6 is pre-assembled appropriately, such that the cutting edges 11 are oriented as to be parallel to the direction of longitudinal extension 10 and parallel to the electrically conductive fibers 3.

In the electrically conductive material 1 shown, all electrically conductive fibers 3 are interrupted several times in a possible direction of current flow 9, namely as seen in the direction of longitudinal extension 10. For this purpose, a multitude of voids 12, namely bore holes 13, have been introduced into the filament 6. As a result, a current flow oriented in the direction of current flow 9 is forced to proceed at least through partial regions of the matrix 5.

FIG. 2 shows a filament 6 comprising a woven material 14 as a starting material. The woven material 14 consists of electrically conductive fibers 3, namely carbon fibers 4, which are each combined into fiber bundles 15 and/or rovings. The structure 2 made up of electrically conductive fibers 3, namely the woven material 14 in the filament 6 shown, is also enveloped by the enveloping material 16, which consists of a thermoplastic material. Accordingly, no carbonization and, accordingly, no production of the actual electrically conductive material has been undertaken yet. But the composite of the structure 2, made up of electrically conductive fibers 3 and the enveloping material 16, has already been cut-to-size in order to predetermine the shape of the filament 6. In the context of the example, the cutting edges 11 extend parallel to the warp thread 17 of the woven material 14. As a result, the electrical conductivity of the finished filament 6, namely of the electrically conductive material still to be formed, is determined essentially by the good electrical conductivity of the fibers 3. Moreover, the cutting edges 11 are oriented to be parallel to the direction of longitudinal extension 10 of the filament 6 and parallel to the direction of current flow 9. Alternatively, however, the cutting edges 11 can just as well extend parallel to the weft 18.

FIG. 3 shows a modification of the technique according to FIG. 2 to illustrate a particularly preferred embodiment of the method according to the invention and of the electrically conductive material according to the invention. Here, both cutting edges 11 are inclined with respect to the weft 18 and also with respect to the warp thread 17, such that the electrically conductive material obtainable later on does not have an electrically conductive fiber 3 extend between the two electrical contacts (not shown) of the filament 6 without being interrupted. The shape of the filament 6 and/or of the later electrically conductive material is predetermined by the gap between the cutting edges 11 in this context.

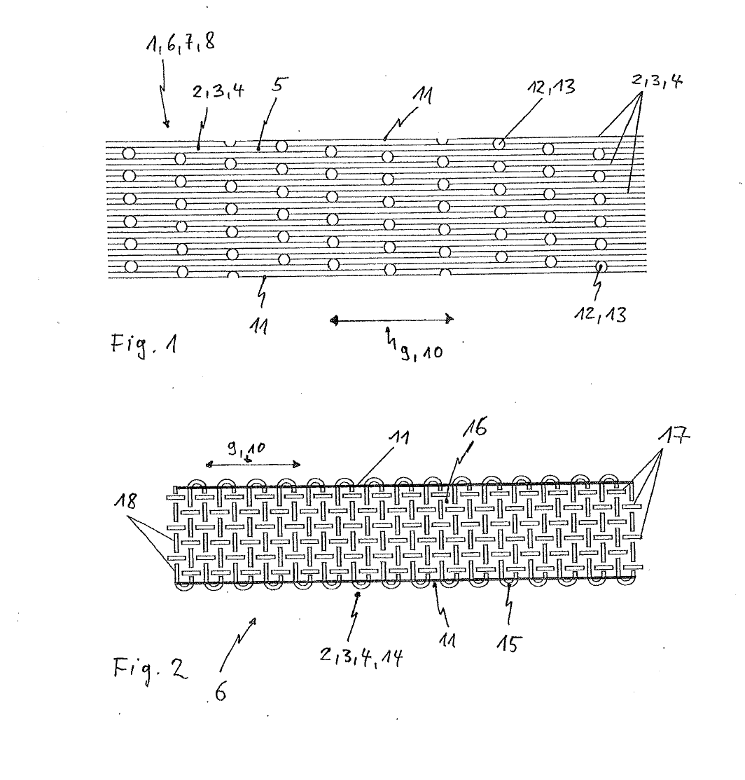

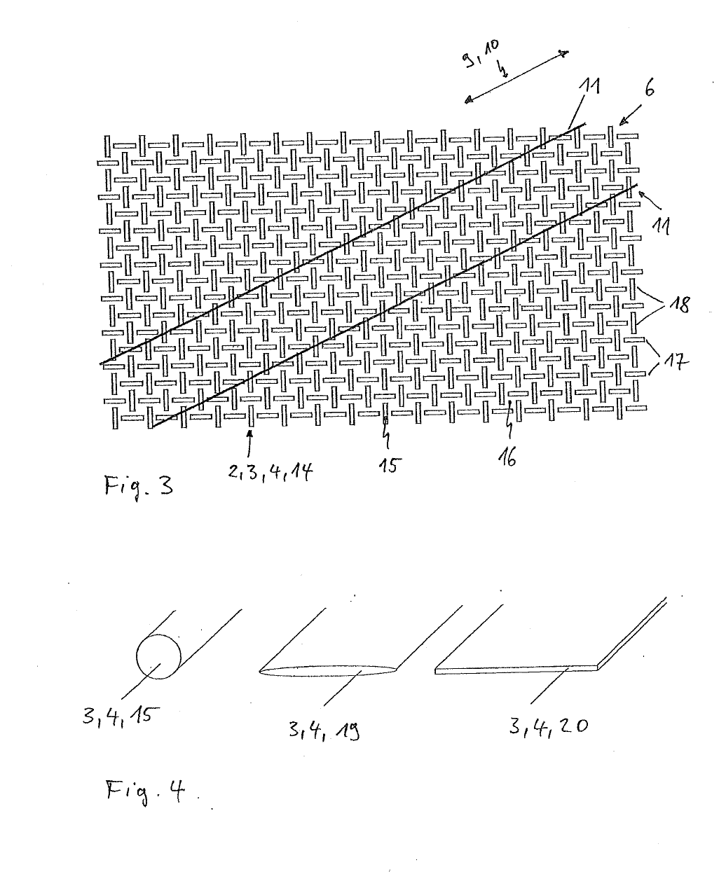

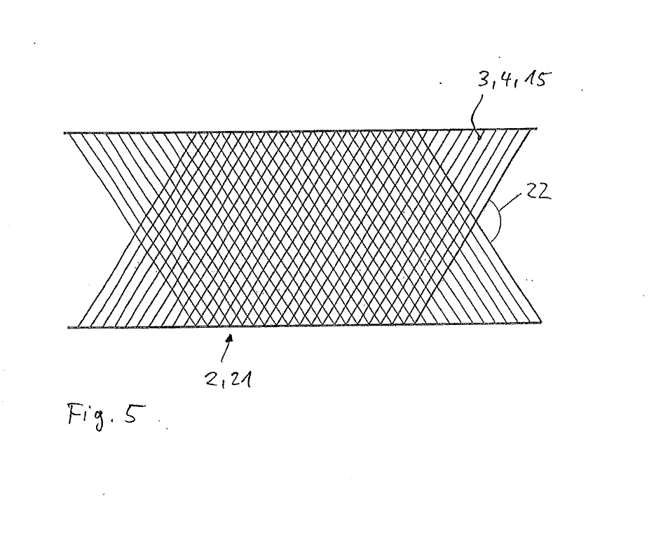

FIG. 4 illustrates in schematic manner another advantageous refinement of the method according to the invention and thus also of the material according to the invention. Accordingly, it is proposed to change the cross-section of the electrically conductive fibers 3, i.e. carbon fibers 4 in the present case, that are combined into fiber bundles or rovings 15. The fiber bundles 15 can be converted into fiber bundles having an elliptical cross-section 19 or into fiber bundles having a rectangular cross-section 20 before or after being worked into the structure made up of electrically conductive fibers. Reducing the gap between the electrically conductive fibers 3 in the structure made up of electrically conductive fibers accordingly allows the electrical properties of the electrically conductive material to be changed in a targeted manner.

FIG. 5 shows a schematic depiction of a structure 2 made up of electrically conductive fibers 3, which are provided in the form of a braided material 21 in the present case. The structure 2 can be used in the implementation of the method according to the invention and for manufacturing the electrically conductive material according to the invention. It has been recognized that the electrical conductivity of the electrically conductive material to be manufactured later on is determined significantly by the angle of twist 22. Accordingly, the invention proposes to influence the electrical conductivity of the structure 2 by varying the angle of twist 22. For this purpose, the braided material 21 can be compressed prior to consolidation. In this context, the angle of twist 22 can take values of up to 160°. The larger the angle of twist 22, the higher is the electrical resistance of the electrically conductive material obtained later on. Accordingly, it has been found that increasing the angle of twist 22 from 45° to 135° C. results in an increase of the resistance by 300%.

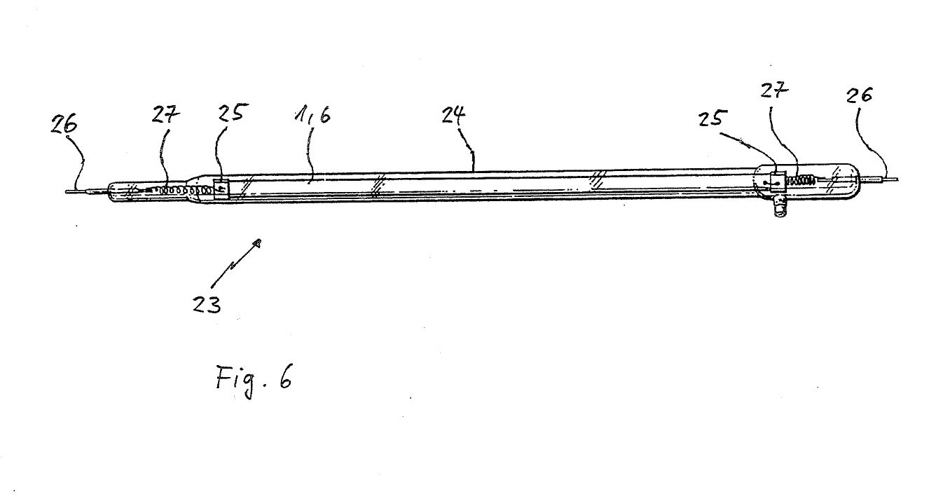

FIG. 6 shows a side view of a preferred exemplary embodiment of an emitter 23 according to the invention, which is provided as an infrared emitter in the present case. The emitter 23 comprises an electrically conductive material 1, which is provided in the form of an elongated filament 6. In this context, the filament 6 is manufactured from an electrically conductive material 1 according to the invention. The filament 6 is enveloped by a transparent housing 24, which can also be referred to as a shell tube. The housing 24 contains a protective gas, namely argon. Alternatively, the filament 6 can be operated in the housing 24 in a vacuum.

The filament 6 is connected to electrical leads 26 by contacting elements 25. A coil-shaped compensation element 27 is arranged between each of the contacting elements 25 and the electrical leads 26 in order to be able to compensate for the differences in thermal expansion of the housing 24 and filament 6. The electrical leads 26 exit from the housing 24 in a vacuum-tight manner. For this purpose, crimping connections or any other expedient technique for vacuum-tight passthrough can be applied.

### Measuring Methods

### Resistivity

The stated values of the resistivity refer to a determination by a measuring method in accordance with DIN IEC 60093:1983; Test Methods for Electro-Insulating Materials; Specific Through Resistance and Specific Surface Resistance of Solid, Electrically-Insulating Materials.

### Electrical Conductivity, Specific Electrical Conductivity, and Electrical Resistance

The conductivity of the electrically conductive material can be measured in cold condition and/or before integration into an emitter or the like, using a resistance measuring device or a conductivity measuring device, wherein the geometrical dimensions of the electrically conductive material, in particular a filament, determined by a measuring tape or slide ruler (length, width, thickness) and the electrical resistance as measured can also be used to calculate the resistivity (see above).

The electrical resistance of the electrically conductive material, integrated into an emitter and/or during its intended use, can be calculated from a measurement of the voltage drop across the emitter and measurement of the current flowing through the emitter by applying Ohm's law. Moreover, if the geometrical dimensions of the electrically conductive material have been determined prior to integrating the electrically conductive material into the emitter, the temperature-dependent value of the resistivity of the electrically conductive material can also be calculated by this means. This method for calculation of the resistivity is preferred, since the measurement it includes cannot be falsified by the contact resistance.

### Specific Conductivity of the Fibers and Matrix Material

The specific electrical conductivity can be determined by performing separate measurements on the electrically conductive fibers before using them for the manufacture of the electrically conductive material, and on the matrix material. Matrix material without electrically conductive fibers can be obtained, e.g. by subjecting 50 g of the enveloping material (e.g. a thermoplastic polymer) to heat treatment at approx. 980° C. for approx. 60 min in the absence of air.

### Distribution of Fiber Lengths

The fiber lengths can be determined by geometrical means. The average fiber length and the fiber length distribution can be derived from the values.

### Flexibility of the Electrically Conductive Material

The flexibility can be determined by bending the electrically conductive material along its entire length into a circle having a radius of, preferably, approx. 0.25 m-1.0 m. The absence of fractures of the electrically conductive fibers and/or matrix and/or the absence of separation of the electrically conductive fibers and matrix is a measure of the flexibility of the electrically conductive material. For example, electrically conductive materials are considered to be particularly flexible if they can be bent about a circular profile having a radius of 0.25 m. In order to pass the flexibility test at a constant radius, the electrically conductive material should always have a tendency to return to the extended shape imparted on it.

Non-limiting exemplary embodiments of the invention, in particular of the method according to the invention and thus of the electrically conductive material according to the invention as well, are illustrated in more detail in the following. Insofar as the exemplary embodiments refer to the figures illustrated above, corresponding text passages are provided with the corresponding reference numbers.

### EXAMPLES

### Exemplary Embodiment 1

Exemplary embodiment 1 relates to the manufacture of a filament according to FIG. 1. Unidirectional thermoplastic carbon fiber tape 8 is used for this purpose, from which the tape-shaped filaments 6 are cut to the needed dimensions (length and width), wherein the length of the filament 6 exceeds its width by far. In this context, the carbon fibers 4 extend in the direction of longitudinal extension 10 of the filament 6, parallel to the cutting edge 11. Subsequently, electrical contacts (not shown) are attached to the filaments 6, the filaments 6 are carbonized, and then graphitized according to need.

The filaments 6 are then provided with bore holes 13 of a diameter of 0.1 mm to 1.5 mm introduced into the material by a laser. The bore holes 13 are arranged appropriately in this context, such that each individual carbon fiber 4 is severed at least once between the two electrical contacts (not shown here). This ensures that the current cannot directly follow along the individual fibers 3, whose electrical conductivity and thermal conductivity in fiber direction is very high, namely in the direction of current flow 9. In the vicinity of the pierced fibers 3, the current needs to transition from the severed fibers 3 to other fibers 3 in the vicinity that have not been pierced in this place.

Depending on the number, arrangement, and diameter of the bore holes 13, the electrical resistance of the filaments 6 can be increased by a factor of up to four. In order to attain a homogenous distribution in the conversion of power into heat without affecting the mechanical integrity of the filament 6 excessively, it has proven to be advantageous to introduce bore holes 13 having a diameter of 0.2 mm to 0.5 mm and the number of bore holes 13 to be from 1 per cm² to 100 per cm². FIG. 1 illustrates a filament 6 of this type in exemplary manner. The figure schematically shows the bore holes 13 and individual carbon fibers 4 of the unidirectional thermoplastic carbon fiber tape 8.

Subsequently, the filaments 6 can be provided with electrical leads (not shown here), can be introduced into quartz tubes and the quartz tubes can be closed in appropriate manner, such that a protective gas atmosphere, preferably of argon, can be present inside the emitter tube (emitter tube) thus formed. Finally, ceramic elements and electrical leads (not shown) are attached to the outside according to need. In this regard, reference is made in exemplary manner to the depiction and description according to FIG. 6.

### Exemplary Embodiment 2

This exemplary embodiment relates in more detail to FIG. 2 and FIG. 3.

For manufacturing the filament 6, a woven material 14 as starting material is used as structure 2 to be coated with a thermoplastic material as an enveloping material 16 and subsequent consolidation. The tape-shaped filaments 6 are then cut to the requisite dimensions from the composite.

The woven material 14 consists of carbon fibers 4, which, as fiber bundles 15 and/or rovings (these terms are used synonymously herein), consist of as few fibers 3 as possible. Particularly well-suited are rovings 15 and/or bundles of 25 tex to 100 tex (1 tex is defined as 1 g per 1,000 meters of fiber length) both as warp thread 17 and as weft 18. Rovings 15 made of carbon fibers 4 of 0.5 k, 1 k or 3 k can be used, wherein 0.5 k and 1 k are to be preferred.

The woven material 14 is produced in plain weave, twill weave or any other type of weave and attains a weight per unit area of 30 g/m² up to maximally 500 g/m². A thermoplastic material in the form of a powder or in the form of thin films covering the woven material is applied onto the woven material 14 as enveloping material 16. Though different thermoplastic materials, e.g., polypropylene (PP), polyamide (PA), polybutyleneterephthalate, polyethyleneterephthalate (PET), polycarbonate (PC), polysulfone, polyphenyleneether (PPE), polyphenylenesulfide (PPS), polyetheretherketone (PEEK), polyetherimide (PEI), polyethersulfone, and/or mixtures thereof can be used, the use of PEEK is to be preferred.

The quantity of powder applied in the process is ideally appropriate such that a fiber volume fraction of approx. 60% in the composite of fiber and enveloping material is attained. The enveloping material 16 is applied homogeneously onto the surface of the woven material 14 to be coated. Even distribution is preferably implemented by a shaker that applies the thermoplastic powder onto the woven material 14 running off The woven material 14 thus coated is consolidated in the subsequent processing step, preferably in an autoclave or a hot-press at a temperature between 350° C. and 425° C. and a pressure of 6 to 9 bar. These processing steps pre-define the later electrical properties of the filament 6. The specific electrical conductivity can be adjusted through the selection of the carbon fiber 4, selection of the enveloping material 16, and by the volume fraction of the consolidated composite accounted for by the enveloping material 16. The electrical resistance is influenced further by the weight per unit area (i.e., the mass per area of the consolidated composite).

Then, filaments 6 of requisite width and length are cut from the consolidated composite. As shown in FIG. 2, the cutting edges 11 can extend parallel to the warp thread 17 in this context, such that the electrical conductivity of the filament 6 is determined significantly by the very good electrical conductivity of the carbon fibers 4 in the fiber direction. Alternatively, the cutting edges 11 can just as well extend parallel to the weft 18 (alternative not shown).

However, if the cutting edges 11 of the filament 6 extend such that each carbon fiber 4 of the consolidated composite is severed when the individual filaments 6 are cut-to-size from the woven material 14, such that no fiber 3 extends directly between the two electrical contacts (not shown) of the electrical filament 6 without being severed, the electrical conductivity of the filament 6 is reduced significantly since the conductivity transverse to the fiber direction is much lower. This kind of cutting is shown in FIG. 3. Accordingly, the electrical resistance of the filaments 6 can be adjusted significantly by the selection of the angle between the cutting edge 11 and the fiber direction (i.e., warp thread 17 or weft 18) in the consolidated composite.

After cutting, electrical contacts (not shown) are attached to the filaments 6, the filaments 6 are carbonized, and then graphitized according to need.

Subsequently, the filaments 6 can be provided with the customary electrical leads, can be introduced into quartz tubes, and the quartz tubes can be closed in appropriate manner, such that a protective gas atmosphere, preferably of argon, is present inside the emitter tube. Finally, ceramic elements and electrical leads are attached to the outside according to need. In this regard, reference is made in exemplary manner to the depiction and description according to FIG. 6.

This allows, in particular, a suitable filament 6 to be manufactured easily and rapidly for different technical requirements on filaments 6—these are defined by the nominal voltage, the requisite nominal power upon application of the nominal voltage, and the length of the filament 6.

### Exemplary Embodiment 3

In a refinement of exemplary embodiment 2, another procedural step precedes the process of coating and consolidation of the woven material 14 with the enveloping material. The fiber bundles 15 used for producing the woven material 14 are initially reworked in terms of their shape from a largely round bundle cross-section to a fiber bundle having an elliptical cross-section 19 and/or a fiber bundle having a rectangular cross-section 20, as is illustrated in FIG. 4.

Preferably, this is achieved by the woven material 14 according to FIG. 3 running loosely over a blower or the woven material being guided through rollers. In the process, the fibers 3 are distributed homogeneously over the given surface. The voids that are initially present in the woven material 14 close virtually completely and the woven material 14 gets flatter.

### Exemplary Embodiment 4

In a refinement of exemplary embodiment 3, the individual fiber bundles are initially spread to maximal width and minimal thickness at which a homogeneous distribution of the fibers is ensured. In the methods applied for this purpose, this corresponds to 1,000 fibers on a width of maximally 2 mm. The spread rovings are subsequently processed into a woven material without the shape produced earlier changing in the process. In this context, carbon fiber rovings can be used as warp or weft with up to 24,000 fibers per roving. This allows very thin woven materials to be manufactured.

### Exemplary Embodiment 5

In a refinement of exemplary embodiments 1 to 4, the filament is subjected to another process, in which carbon is removed in a targeted manner. For this purpose, the emitter filament is heated to a temperature of more than 400° C., and a hydrogen-argon mixture is streamed over it. Setting the process parameters appropriately—these include the composition of the gas mixture, the flow rate, the pressure, the temperature of the emitter filament, and the duration of the process—allows the carbon removal rate to be varied. This has an influence on the thickness of the filament and thus adjusts the electrical resistance. This allows the electrical resistance of the emitter filament to be increased by a factor of up to 2.7-fold without compromising the mechanical integrity of the filament.

### Exemplary Embodiment 6

A braided material 21 of electrically conductive fibers 3 as shown schematically in FIG. 5, is used to manufacture the filament. The braided material 21 is coated with a thermoplastic material and subsequently consolidated. Then, filaments of the requisite dimensions are cut from the composite thus produced.

The braided material 21 consists of carbon fibers 4, which consist of fiber bundles 15 containing the smallest possible number of fibers 3. Particularly well-suited are rovings 15 or bundles of 25 tex to 100 tex (1 tex is defined as 1 g per 1,000 meters of fiber length). Rovings 15 made of carbon fibers 4 of 0.5 k, 1 k or 3 k can be used accordingly (1 k corresponds to 1,000 fibers 3 per bundle 15).

Manufactured as a single-braided or double-braided material 21, the braided material 21 can reach a weight per unit area of 30 g/m² up to maximally 500 g/m². A thermoplastic material in the form of a powder or in the form of films covering the braided material is applied as the enveloping material onto the braided material 21. Though different thermoplastic materials, e.g., polypropylene (PP), polyamide (PA), polybutyleneterephthalate, polyethyleneterephthalate (PET), polycarbonate (PC), polysulfone, polyphenyleneether (PPE), polyphenylenesulfide (PPS), polyetheretherketone (PEEK), polyetherimide (PEI), polyethersulfone and/or mixtures thereof can be used, the use of PEEK is to be preferred.

The quantity of powder applied in the process is ideally appropriate such that a fiber volume fraction of approx. 60% in the composite of fiber and enveloping material is attained. The thermoplastic enveloping material is applied homogeneously onto the surface of the braided material 21 to be coated. Even distribution is preferably implemented by a shaker that applies the thermoplastic powder onto the woven material 21 running off. The braided material 21 thus coated is consolidated in the subsequent processing step, preferably in an autoclave or a hot-press at a temperature between 350 and 425° C. and a pressure of 6 to 9 bar. These processing steps pre-define the electrical properties of the filament obtained later on. In this context, the electrical conductivity can be adjusted by the selection of the carbon fiber 4, selection of the enveloping material, namely, in particular, a thermoplastic material, via the weight per unit area (i.e., the mass per area of the consolidated composite), and via the volume fraction of the consolidated material that is accounted for by the enveloping material.

Then, the filaments of requisite width and length are cut from the consolidated composite of braided material 21 and enveloping material. In this context, the cutting edge of the filament is oriented appropriately such that each carbon fiber 4 of the braided material 21 is severed. This process is shown in FIG. 4 for a woven material and has been illustrated in detail based on the figure.

In this context, the electrical conductivity is defined to a significant extent by the angle of twist 22, see FIG. 5.

At an angle of twist 22 of 45°, the electrical conductivity of the filament is reduced and/or the electrical resistance of the filament is increased by a factor of up to three as compared to a filament of the same thickness that is made of a unidirectional carbon fiber tape.

Subsequently, electrical contacts (not shown here, FIG. 5 only shows the braided material 21) are attached to the filaments, the filaments are carbonized and then graphitized according to need.

Subsequently, the filaments can be provided with the customary electrical leads, can be introduced into quartz tubes, and the quartz tubes can be closed in appropriate manner, such that a protective gas atmosphere, preferably of argon, can be present inside the emitter tube. Finally, ceramic elements and electrical leads can be attached to the outside according to need. In this regard, reference is made in exemplary manner to the depiction and description according to FIG. 6.

### Exemplary Embodiment 7

In a refinement of exemplary embodiment 6, the braided material 21 according to FIG. 5 can be compressed prior to consolidating it. The degree of compression can be used to influence the angle of twist 22, which can take values of up to 160°. The larger the angle of twist 22, the higher is the electrical resistance of a filament made from the braided material 21.

Varying the angle of twist 22 allows the resistance of the filaments to be adjusted significantly. Increasing the angle of twist 22 from 45° to 135° C. results in an increase of the resistance by 300%.

### Exemplary Embodiment 8

A unidirectional thermoplastic carbon fiber tape is used for manufacture of the filament. Unidirectional thermoplastic carbon fiber tapes are preferably produced by laminating two layers onto each other in an autoclave at a temperature between 350 and 425° C. and at a pressure of 6 to 9 bar. The angle of the unidirectional fiber orientation of the two tapes with respect to each other can be selected as desired in this context. This angle has a significant influence on the resistance of the emitter filaments. In addition, the resistance of the finished emitter filaments is also defined by the selection of the cutting direction that is used cutting the filaments to size.

Subsequently, electrical contacts are attached to the filaments, the filaments are carbonized, and then graphitized according to need.

Subsequently, the filaments can be provided with the customary electrical leads, can be introduced into quartz tubes, and the quartz tubes can be closed in appropriate manner such that a protective gas atmosphere, preferably of argon, is present inside the emitter tube. Finally, ceramic elements and electrical leads are attached to the outside according to need. In this regard, reference is made in exemplary manner to the depiction and description according to FIG. 6.

### Exemplary Embodiment 9

A braided starting material in the form of a tape or a litz wire is used for manufacture of the filament. The tape or litz wire is broader than the finished emitter filament. The braided starting material consists of carbon fibers, which in turn consist of fiber bundles of the smallest possible number of fibers. Particularly well-suited are rovings or bundles of 25 tex to 100 tex (1 tex is defined as 1 g per 1,000 meters of fiber length). Rovings made of carbon fibers of 0.5 k, 1 k or 3 k (1 k=1,000) fibers per fiber bundle can be used accordingly.

Subsequently, electrical contacts are attached to the braided tapes, the tapes are carbonized, and then graphitized according to need.

Subsequently, the braided tape is subjected to a CVD/CVI process, in which an amorphous carbon structure consisting of a mixture of sp²- and sp³-hybridized carbon is attached to the braided tape and between the fibers. The amorphous carbon structure leads to a stabilization of the shape of the braided tape and to adherence of the individual fibers to each other. Moreover, the structure has a low electrical conductivity, which has the effect to increase the resistance of the finished emitter filament. Subsequently, the emitter filament is cut from the braided tape thus coated and infiltrated by cutting through each carbon fiber of the braided material at least once.

Subsequently, the filaments can be provided with the customary electrical leads, can be introduced into quartz tubes, and the quartz tubes can be closed in appropriate manner, such that a protective gas atmosphere, preferably of argon, is present inside the emitter tube. Finally, ceramic elements and electrical leads are attached to the outside according to need. In this regard, reference is made in exemplary manner to the depiction and description according to FIG. 6.

Finally, it should be noted that thermoplastic materials are preferred enveloping materials in the exemplary embodiments described above. However, the selection of enveloping materials is not limited to thermoplastic materials only; rather, duroplastic materials, possibly in a mixture that also contains thermoplastic materials, can be used as enveloping materials. In general, any material can be used as an enveloping material if it can be converted in expedient manner into a matrix, namely, in particular, by exposure to heat, preferably by carbonization.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the invention as defined by the appended claims.

1.-23. (canceled)

24. A method for manufacture of an electrically conductive material, the method comprising the steps of:
a) providing a structure made of electrically conductive fibers; and
b) producing a carbon-based, electrically conductive matrix that at least partially envelopes the electrically conductive fibers;
wherein, before or after producing the matrix, at least part of the electrically conductive fibers are interrupted in a direction of possible current flow.

25. The method according to claim 24, wherein the electrically conductive material has a carbon content of at least 95 mass %.

26. The method according to claim 24, wherein the electrically conductive fibers are selected from carbon fibers, silicon carbide fibers, fibers having ceramic components, or a mixture of at least two of these.

27. The method according to claim 24, wherein a specific electrical conductivity of the matrix is lower than that of the electrically conductive fibers.

28. The method according to claim 24, wherein the matrix is produced by a high temperature treatment of a material selected from thermoplastic and duroplastic materials that envelopes the structure made of electrically conductive fibers in a temperature range of 600° C. to 1,500° C.

29. The method according to claim 28, wherein the thermoplastic material is selected from polypropylene, polyamide, polybutyleneterephthalate, polyethyleneterephthalate, polycarbonate, polysulfone, polyphenylether, polyphenylenesulfide, polyetheretherketone, polyphthalamide, polyetherimide, polyethersulfone, and a mixture of at least two of these.

30. The method according to claim 28, wherein the duroplastic material is selected from a vinylester resin, a phenol resin, an epoxide resin, and a mixture of at least two of these.

31. The method according to claim 24, further comprising the steps of:
c) providing the structure made up of electrically conductive fibers by a two-dimensional precursor structure containing electrically conductive fibers;
d) carbonizing fractions of the two-dimensional precursor structure that are not the electrically conductive fibers; and
e) interrupting at least a part of the electrically conductive fibers by introducing voids, optionally bore holes.

32. The method according to claim 31, wherein the two-dimensional precursor structure is a tape cut-to-size before the carbonizing step.

33. The method according to claim 24, wherein the structure made of electrically conductive fibers is selected from the group consisting of:
a plurality of fiber bundles;
a woven material made of fibers or a plurality of fiber bundles or at least two of these;
a braided material made of fibers or a plurality of fiber bundles or at least two of these;
a knitted material made of fibers or a plurality of fiber bundles or at least two of these;
a knitted fabric made of fibers or a plurality of fiber bundles or at least two of these; and
a combination of at least two of these.

34. The method according to claim 33, wherein, for production of the matrix, the structure made of electrically conductive fibers is enveloped with an enveloping material, and wherein a composite thus generated is cut-to-size appropriately before a subsequent step of graphitizing, such that at least part of the electrically conductive fibers are interrupted as seen in a direction of current flow through the electrically conductive material.

35. The method according to claim 34, wherein a cutting edge defining a direction of longitudinal extension of the electrically conductive material,
in a case of a woven material, is inclined at an angle of 20° to 70° with respect to a weft, or
in a case of a braided material, extends parallel to an edge of the braided material.

36. The method according to claim 34, wherein the composite of electrically conductive fibers and enveloping material is obtained by mixing the electrically conductive fibers and the enveloping material as a two-dimensional precursor structure in the form of a prepreg.

37. The method according to claim 34, wherein the composite of electrically conductive fibers and enveloping material is obtained by vapor deposition of the enveloping material onto the electrically conductive fibers as a two-dimensional precursor structure in a form of a deposition structure before being cut-to-size.

38. The method according to claim 34, further comprising at least one of the following steps: reducing thickness of fiber bundles before introduction into the structure, and reducing thickness of the fiber bundles within the structure after production of the structure.

39. The method according to claim 34, wherein an angle of twist between mutually crossing fibers or fiber bundles or both within the structure made up of electrically conductive fibers deviates from 90° in either case.

40. The method according to claim 24, wherein carbon is removed from the electrically conductive material.

41. An electrically conductive material obtained by the method according to claim 24.

42. An electrically conductive material comprising:
a) a structure made of electrically conductive fibers; and
b) an electrically conductive matrix which at least partially envelopes the electrically conductive fibers;
wherein the electrically conductive fibers exhibit higher specific conductivity than the electrically conductive matrix;
wherein the electrically conductive material extends in a direction of longitudinal extension; and wherein, viewed along the direction of longitudinal extension, at least part of the electrically conductive fibers within the material are interrupted at least once.

43. An electrically conductive material according to claim 42, wherein at least one of the following is true of the electrically conducting fibers: the electrically conductive fibers are interrupted in the electrically conductive material as seen in the direction of longitudinal extension: the electrically conductive fibers extend in a direction inclined with respect to the direction of longitudinal extension; and the electrically conductive fibers have one or more voids introduced in them.

44. An electrically conductive material according to claim 42, wherein at least 50 mass % of the fibers in the electrically conductive material have a fiber length of no more than 0.5 m.

45. An emitter comprising:
a) a transparent or translucent housing; and
b) an electrically conductive material according to claim 42 arranged in the housing.

46. The emitter according to claim 45, wherein the electrically conductive material has appropriate flexibility, such that the electrically conductive material can be bent into a circle and over its entire length about a radius of 1.0 m without fracturing the electrically conductive fibers and/or the matrix and/or without separating the electrically conductive fibers and the matrix.

47. The emitter according to claim 46, wherein the flexibility is such that the electrically conductive material can be bent into a circle and over its entire length about a radius of 0.25 m without fracturing the electrically conductive fibers and/or the matrix and/or without separating the electrically conductive fibers and the matrix.

48. The emitter according to claim 45, wherein electrical conductivity of the electrically conductive material, measured as electrical operating voltage per unit of length of the electrically conductive material, exceeds 150 V/m.
